(19) United States
(12) Patent Application Publication
(10) Pub. No.: US 2022/0400805 A1
(43) Pub. Date: Dec. 22, 2022

(54) PHOTOCHROMIC HELMET VISOR

(71) Applicant: CHI-LIANG WEI, Yonghe Dist (TW)

(72) Inventor: CHI-LIANG WEI, Yonghe Dist (TW)

(21) Appl. No.: 17/353,801

(22) Filed: Jun. 21, 2021

(51) Int. Cl. A42B 3/22; B32B 27/28; B32B 27/40; B32B 7/12

(52) U.S. Cl. CPC A42B 3/227; B32B 27/283; B32B 27/40; B32B 7/12; B32B 2307/762; B32B 2307/412; B32B 2307/404; B32B 2437/04

(57) ABSTRACT

The photochromic helmet visor includes a transparent piece, an adhesive layer attached to the transparent piece, a flexible base layer attached to the adhesive layer, a self-repairing layer attached to the flexible base layer, and a number of photochromic elements integrated with the flexible base layer or the self-repairing layer. The self-repairing layer includes a. PU layer and a. Siloxane layer attached to the PU layer. The photochromic elements are integrated with the flexible base layer or the self-repairing layer. The flexible base layer is made of PU, TPU, PVC, or PET, and may be tightly and smoothly joined to the transparent piece along with the adhesive layer. The self-repairing layer allows self-repairing to scratches or abrasions under a high temperature, thereby preventing the malfunction of the photochromic elements out of wear and usage and the resulted constant replacement, and enhancing the visor's durability.

### (a) TECHNICAL FIELD OF THE INVENTION

The present invention is generally related helmet visors, and more particular to a photochromic visor capable of self-repairing for motorcycle helmets.

### (b) Description of the Prior Art

A helmet is usually equipped with a visor for protecting the eyes. The visor is often of high transparency to provide the driver a clear view. However, to shade the eyes from the bright light of the sun, there are photochromic visors that darkens on exposure to sun light and becomes clear in the absence of light.

A photochromic visor is usually achieved by having a photochromic film on the visor by sputtering, spraying, or soaking. However, once the film is scratched or worn, the film may peel off or the damaged part fails to function. Then, the visor or the helmet has to be replaced, which is a costly burden to the user.

The photochromic film is usually attached to the outside of the visor and, as such, is susceptible to scratch and wear. If the photochromic film is attached to the inside of the visor, the blocking of the visor may delay the film's darkening and clearing, which is also not an appropriate solution.

### SUMMARY OF THE INVENTION

A major objective of the present invention is to provide a novel photochromic helmet visor which includes a flexible base layer for tight and smooth attachment to the visor and a self-repairing layer for repairing scratch or wear.

To achieve the objective, the photochromic helmet visor includes a transparent piece, an adhesive layer, a flexible base layer, a self-repairing layer, and a number of photochromic elements. The adhesive layer is attached to an outer side of the transparent piece, and the flexible base layer is matched and attached to the adhesive layer. The flexible base layer is made of Polyurethane (PU), Thermoplastic polyurethanes (TPU), Polyvinyl Chloride (PVC), or Polyethylene terephthalate (PET). The self-repairing layer is attached to the flexible base layer and includes a PU layer and a Siloxane layer. The Siloxane layer is attached to an inner side of the PU layer. The photochromic elements are integrated with the flexible base layer or the self-repairing layer.

The photochromic elements become darken when exposed to ultraviolet light or transparent in the absence of sun light, thereby automatically providing eye protection. Due to the high flexibility of the flexible base layer, it may be stretched along various directions conforming to the adhesive layer to achieve smooth and tight attachment. Warm air or steam may be applied to soften and shrink the flexible base layer to reduce the stress resulted from its curvature. The self-repairing layer's KJ layer and Siloxane layer allow self-repairing to scratches or abrasions under a high temperature, thereby preventing the malfunction of the photochromic elements out of wear and usage and the resulted constant replacement, and enhancing the visor's durability.

As such, the photochromic helmet visor resolves the shortcomings of the prior art such as ill attachment, constant replacement due to scratches, etc.

The foregoing objectives and summary provide only a brief introduction to the present invention. To fully appreciate these and other Objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a photochromic helmet visor according to a first embodiment of the present invention fixed on a helmet.

FIG. 2 is a perspective break-down diagram showing a photochromic helmet visor according to a first embodiment of the present invention.

FIG. 3 is a profile diagram showing an application scenario of the photochromic helmet visor of FIG. 2.

FIG. 4 is a perspective diagram showing another application scenario of the photochromic helmet visor of FIG. 2.

FIG. 5 is a perspective break-down diagram showing a photochromic helmet visor according to a second embodiment of the present invention.

FIG. 6 is a perspective diagram showing a photochromic helmet visor of FIG. 5 when it is assembled.

### DETAILED DESCRIPTION OF FIE PREFERRED EMBODIMENTS

The following descriptions are exemplary embodiments only, and are not intended to limit the scope, applicability or configuration of the invention any way. Rather, the following description provides a convenient illustration for implementing exemplary embodiments of the invention. Various changes to the described embodiments may be made in the function and arrangement of the elements described without departing from the scope of the invention as set forth in the appended claims.

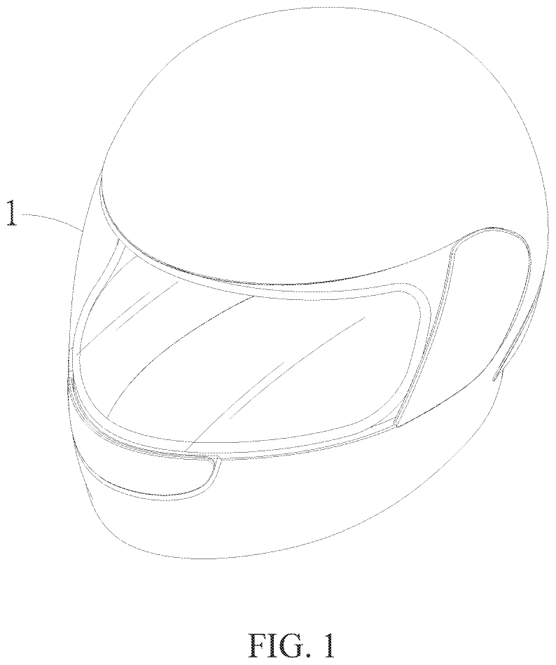

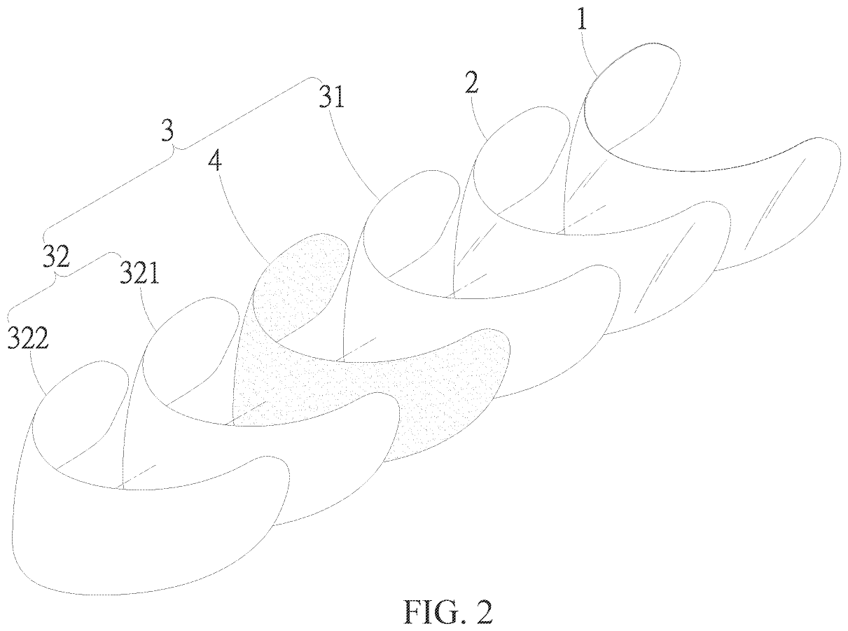

As shown in FIGS. 1 and 2, a photochromic helmet visor according to a first embodiment of the present invention includes:

A transparent piece 1;

an adhesive layer 2 attached to a front side of the transparent piece 1;

a flexible base layer 31 attached to a front side of the adhesive layer 2 opposite to the transparent piece it, where the flexible base layer 31 is made of Polyurethane (PU), Thermoplastic polyurethanes (TPU), Polyvinyl Chloride (PVC), or Polyethylene terephthalate (PET);

a self-repairing layer 32 attached to a front side of the flexible base layer 31 opposite to the adhesive layer 2, where the self-repairing layer 32 includes a Polyurethane (PU) layer 321, and a Siloxane layer 322 attached to a front side of the PU layer 321, and

a number of photochromic elements 4 are applied to the flexible base layer 31 or the self-repairing layer 32.

Specifically, in the present embodiment, the transparent piece 1 is a transparent lens having a curved surface curved toward a front direction. The adhesive layer 2 is a layer of fully transparent adhesive. The flexible base layer 31 is a thin film made of PU, TPU, PVC, or PET. The photochromic elements 4 are powdery or liquid Silver chloride or Silver halide. In the present embodiment, the photochromic elements 4 are coated on the front side of the flexible base layer 31 and the self-repairing layer 32 is then attached to the front side of the flexible base layer 3. The flexible base layer 31, the photochromic elements 4, and the self-repairing layer 32 jointly form a photochromic film 3.

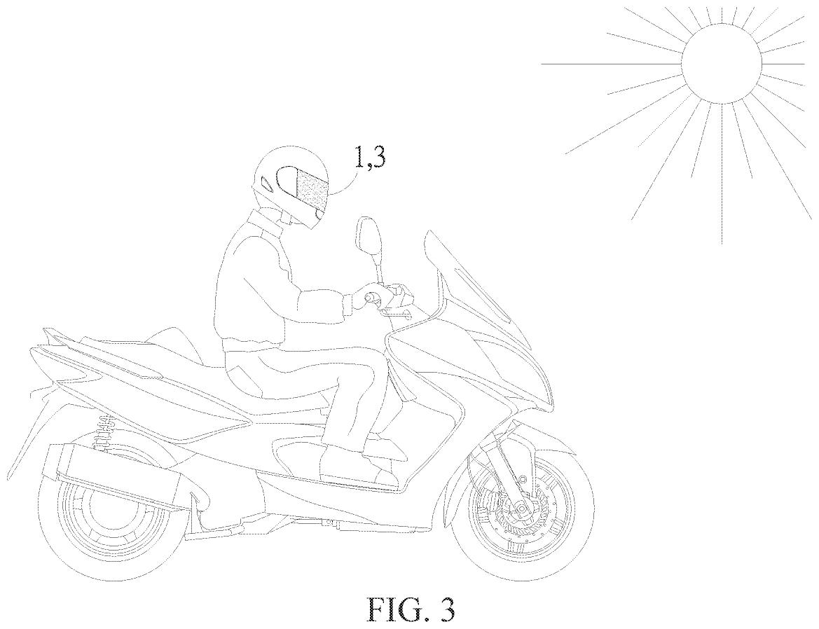

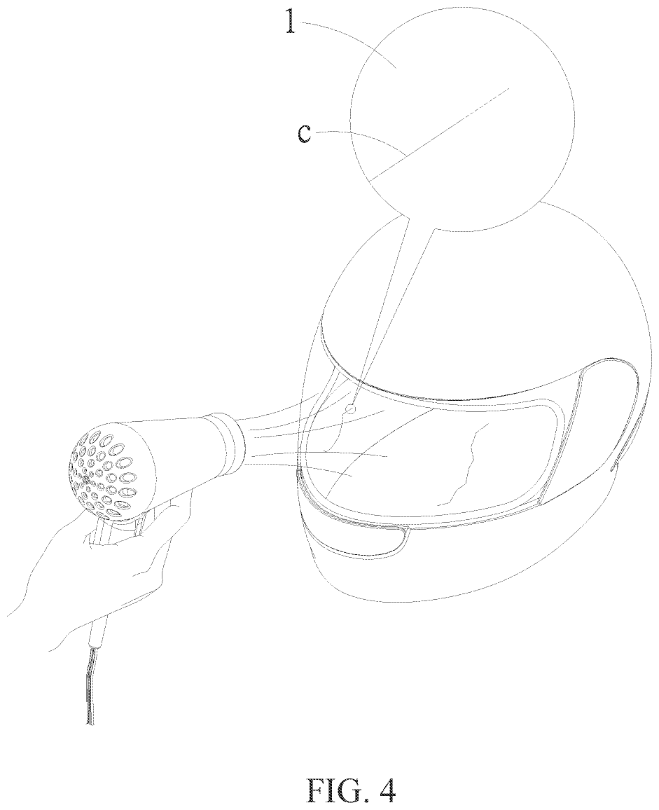

As shown in FIGS. 1 to 4, the photochromic film 3 is joined to the transparent piece 1 through the adhesive layer 2. As the high flexibility of the flexible base layer 31, it may be stretched along various directions conforming to the adhesive layer 2 to achieve smooth and tight attachment. Warm air or steam may be applied to soften and shrink the photochromic film 3 to reduce the stress resulted from its curvature. The photochromic elements 4 become darken when exposed to ultraviolet light, thereby blocking sun light by reducing the transmittance of the transparent piece 1. The photochromic elements 4 then become transparent in the absence of sun light. The self-repairing layer 32 has an appropriate hardness and abrasion resistance. With its PU layer 321 of high crosslink density and its organic-modified Siloxane layer 322, the self-repairing layer 32 may automatically repair its scratches when ambient temperature reaches above 50° C. The self-repairing layer 32 is made of a polymer material that is stable under room temperature. Scratches are actually broken molecular bonds resulted from external force. These broken molecular bonds of the self-repairing layer 32 may be restored after supplying appropriate amount of heat (preferably over 60° C.). As shown in FIG. 4, the scratch C may be automatically repaired, where the dashed line indicates the part of the scratch C repaired, by blowing hot air to the self-repairing layer 32 using, for example, a hair dryer.

Even without external impact, as the air is full of various particles, the transparent piece 1 would suffer a large number of tiny scratches C without the protection of the self-repairing layer 32, and the photochromic elements 4 may also be damaged. Therefore, by integrating the self-repairing layer 32, photochromic elements 4, and the flexible base layer 31 together, they not only may be tightly and smoothly attached to the transparent piece 1, but also achieve photochromic eye protection and enhanced operation life by self-repair.

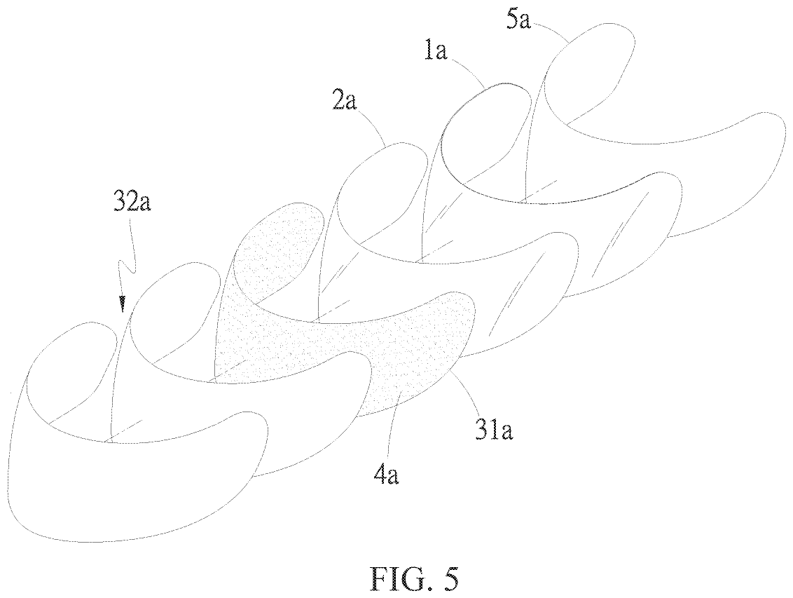

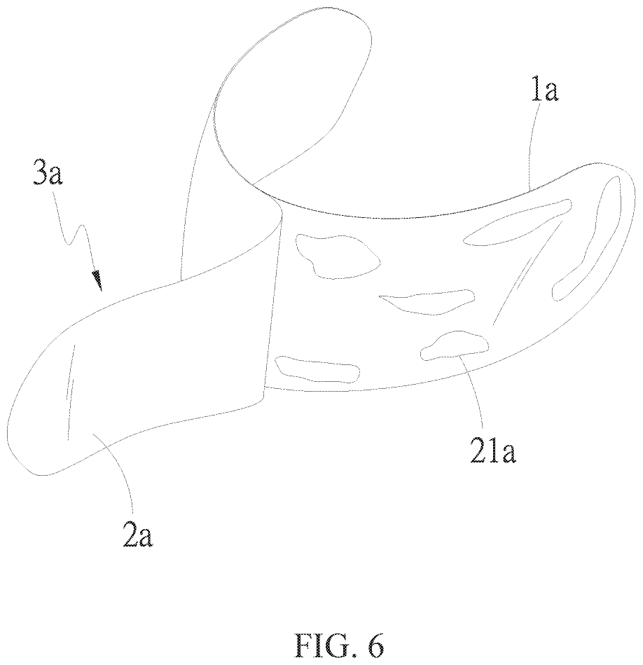

As shown in FIGS. 5 and 6, a photochromic helmet visor according to a second embodiment of the present invention is structured similarly to the previous embodiment except that there is an additional anti-fog layer 5a attached to a back side of the transparent piece 1a, and the adhesive layer 2a is made of a hydrophilic adhesive. In addition, the photochromic elements 4a are distributed evenly within the flexible base layer 31a. In an alternative embodiment, the photochromic elements 4a may also be distributed evenly within the self-repairing layer 32a. The anti-fog layer 5a prevents the warm air exhaled by the user from fogging transparent piece 1a. In addition, to attach the adhesive layer 2a to the transparent piece 1a, soapy water 21a is sprayed on transparent piece 1a first. The adhesive layer 2a is then applied on the soapy water 21a. By the lubrication of the soapy water 21a, the adhesive layer 2a may be slid on the transparent piece 1a and, after the adhesive layer 2a is moved to the desired location, the soapy water 21a is scraped. This way of attachment is less prone to air bubbles or the air bubbles may be easily removed. The positioning of the adhesive layer 2a is also more precise, and there is no need for dust removal.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I CLAIM:

1. A photochromic helmet visor, comprising:
a transparent piece;
an adhesive layer attached to a front side of the transparent piece;
a flexible base layer attached to a front side of the adhesive layer, where the flexible base layer is made of Polyurethane (PU), Thermoplastic polyurethanes (TPU), Polyvinyl Chloride (PVC), or Polyethylene terephthalate (PET);
a self-repairing layer attached to a front side of the flexible base layer, where the self-repairing layer comprises a PU layer, and a Siloxane layer attached to a front side of the PU layer a; and
a plurality of photochromic elements integrated with the flexible base layer or the self-repairing layer.

2. The photochromic helmet visor according to claim 1, further comprising an anti-fog layer transparent piece.

3. The photochromic helmet visor according to claim 1, wherein adhesive layer is made of a hydrophilic adhesive.

4. The photochromic helmet visor according to claim 1, wherein the photochromic elements are evenly distributed within the self-repairing layer.

5. The photochromic helmet visor according to claim 1, wherein the photochromic elements are evenly distributed within the flexible base layer.

6. The photochromic helmet visor according to claim 1, wherein the photochromic elements are configured on the front side of the flexible base layer.

7. The photochromic helmet visor according to claim 1, wherein the self-repairing layer is made of a polymer material capable of self-repairing broken molecular bonds when temperature is above 50° C.

8. The photochromic helmet visor according to claim 1, wherein the transparent piece is a transparent lens having a curved surface curved toward a front direction.
